(19) United States
(12) Patent Application Publication
(10) Pub. No.: US 2010/0259350 A1
(43) Pub. Date: Oct. 14, 2010

(54) INDUCTOR OR TRANSFORMER FOR MICROELECTRIC SYSTEM

(76) Inventors: Jeff Biar, Taipei County (TW); Jacky Lee, Taipei County (TW)

Correspondence Address: Muncy, Geissler, Olds & Lowe, PLLC, 4000 Legato Road, Suite 310, FAIRFAX, VA, 22033, US

(21) Appl. No.: 12/752,529

(22) Filed: Apr. 1, 2010

(30) Foreign Application Priority Data
Apr. 14, 2009 (TW) 98206126

(51) Int. Cl. H01F 27/28

(52) U.S. Cl. 336/200

(57) ABSTRACT

A microinductor comprises an insulating substrate, a lower conductive winding, an upper conductive winding, and a core. The lower conductive winding is disposed on an upper surface of the substrate. The core is made of a material with high permeability and stacked over the lower conductive winding. The upper conductive winding is disposed on an upper surface of the core. The upper conductive winding electrically interconnects with the lower conductive winding so as to form an inductor coil.

### BACKGROUND OF THE INVENTION

1. Field of the Invention

The present invention relates to the field of microelectric systems, and more particularly to microcomponents such as microinductors or microtransformers.

2. Description of the Related Art

In microelectric system, there exists a demand to have small size inductors or transformers with high inductance. To satisfy the demand, U.S. Pat. No. 6,512,285 discloses a high inductance inductor for use in semiconductor packages. The inductor disclosed by this patent has a number of trace metal segments or conductors patterned onto a top surface of a substrate, an insulator layer covering the trace metal segments and separates them from a high permeability core which is mounted on top of the insulator layer, and a number of bonding wires passed over the high permeability core and making connections to respective trace metal segments under the core so as to create an inductor winding around the core. However, such inductors suffer from various disadvantages. For example, for passing over the high permeability core, each of the bonding wires of the inductor must have enough length. And the result is that the inductor has a high resistance and is easily destroyed.

### SUMMARY OF THE INVENTION

The present invention substantially solves the disadvantages enumerated above by providing a microinductor which is suitable for use in microelectric systems. The microinductor comprises an insulating substrate, a lower conductive winding, an upper conductive winding, and a core. The lower conductive winding is disposed on an upper surface of the substrate. The core is made of a material with high permeability and stacked over the lower conductive winding. The upper conductive winding is disposed on an upper surface of the core. The upper conductive winding electrically interconnects with the lower conductive winding so as to form an inductor coil.

The aspect of the present invention can also be applied to a microtransformer being suitable for use in microelectric systems. The microtransformer includes a substrate made of insulating materials, a first lower primary winding, a first secondary winding, a first core made of a material with high permeability, a first primary conductive bonding, a second primary conductive bonding, a first secondary conductive bonding and a second secondary conductive bonding. The substrate has an upper surface. The first lower primary and first secondary windings are disposed on the upper surface of the substrate in a parallel arrangement. The first core includes a magnetic flux path having a first and second leg portions and a first and second arm portions. The microtransformer further includes a first upper primary winding disposed on an upper surface of the first leg portion of the core, and a first upper secondary winding disposed on an upper surface of the second leg portion of the core. The first core is stacked over the upper surface of the substrate in such a way that the first upper primary winding corresponds to the first lower primary winding, and the first upper secondary winding corresponds to the lower secondary winding. The first primary conductive bonding connects the first upper primary winding to the first lower primary winding, and the second primary conductive bonding connects the first upper primary winding to the first lower primary winding so as to form a first primary inductor. The first secondary conductive bonding connects the first upper secondary winding to the first lower secondary winding, and the second secondary conductive bonding connects the first upper secondary winding to the first lower secondary winding so as to form a first secondary inductor.

It can be seen that the microindutor and the microtransformer mentioned here need not long bonding wires as that of prior art so that the disadvantages of prior art are resolved.

### BRIEF DESCRIPTION OF THE DRAWINGS

Objects, features, and advantages of embodiments of the present invention will become apparent by reference to the following detailed description and drawings, wherein:

FIG. 1 is a perspective view of a microinductor embodied according to the present invention;

FIG. 2 is a partly exploded view of the inductor as shown in FIG. 1;

FIG. 3 is a perspective view of a first embodiment of the microtransformer according to the present invention;

FIG. 4 is a partly exploded view of the microtransformer as shown in FIG. 3;

FIG. 5 is a perspective view of a second embodiment of the microtransformer according to the present invention; and

FIG. 6 is a partly exploded view of the microtransformer as shown in FIG. 5.

### DETAILED DESCRIPTION OF PREFERRED EMBODIMENTS

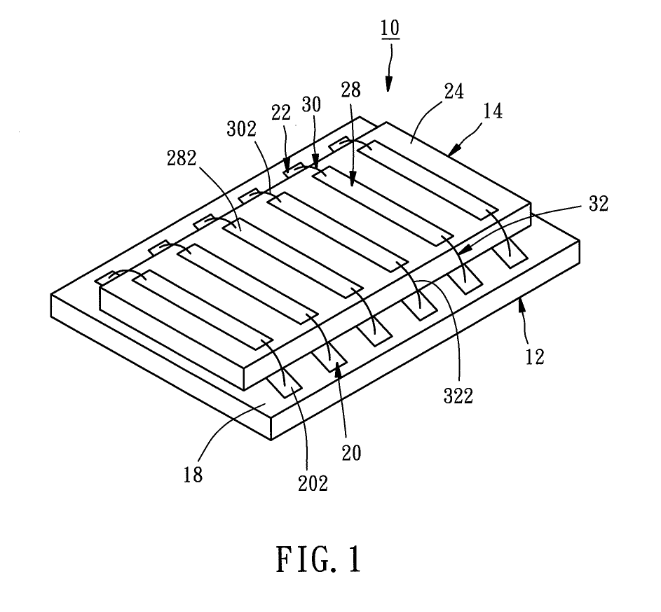

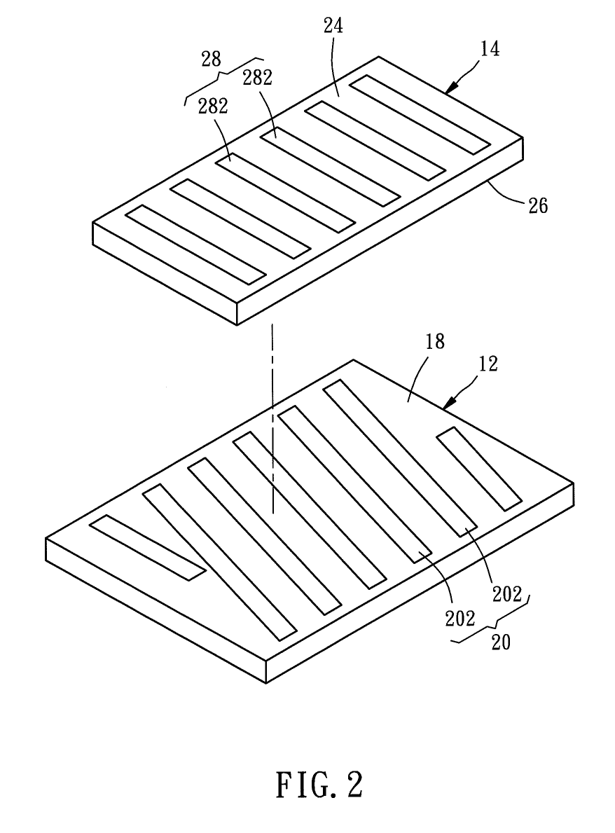

Referring firstly to FIGS. 1 and 2, an inductor 10 embodied according to the aspect of the present invention includes an insulating substrate 12 and a core 14 made of ferrite.

Insulating substrate 12 includes a lower conductive winding 20 disposed on an upper surface 18 thereof. In this embodiment, lower conductive winding 20 is a series of lower conductive segments 202 disposed on upper surface 18 in a parallel arrangement by any prior art method, such as embedded or coated processing.

Core 14 has a top side 24 and a bottom side 26. An upper conductive winding 28 is disposed on top side 24 of core 14. In this embodiment, upper conductive winding 28 is a series of upper conductive segments 282 disposed on top side 24 in a parallel arrangement by any prior art method, such as embedded or coated processing.

Core 14 is stacked over lower conductive winding 20 of substrate 12 in such a way that lower conductive winding 20 and upper conductive winding 28 correspond to each other and are electrically interconnected by a first and second conductive bondings 30, 32 so as to form a complete coil of inductor 10.

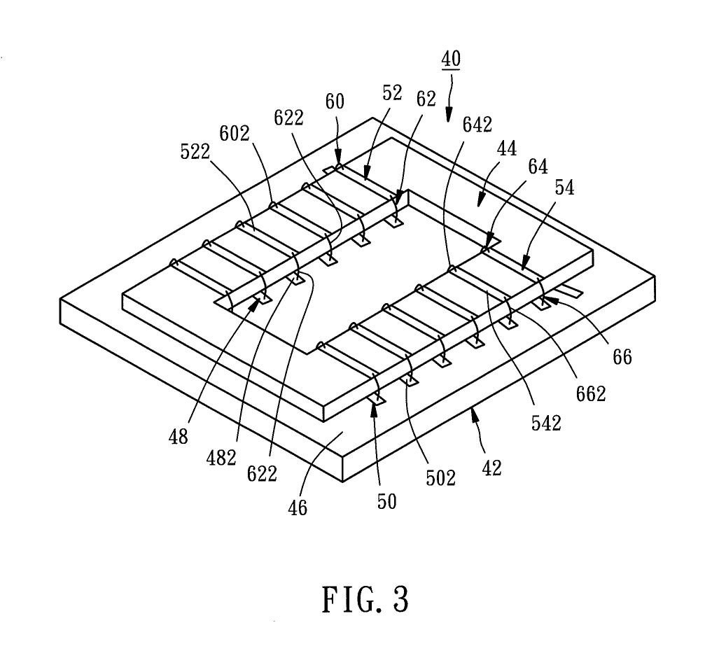

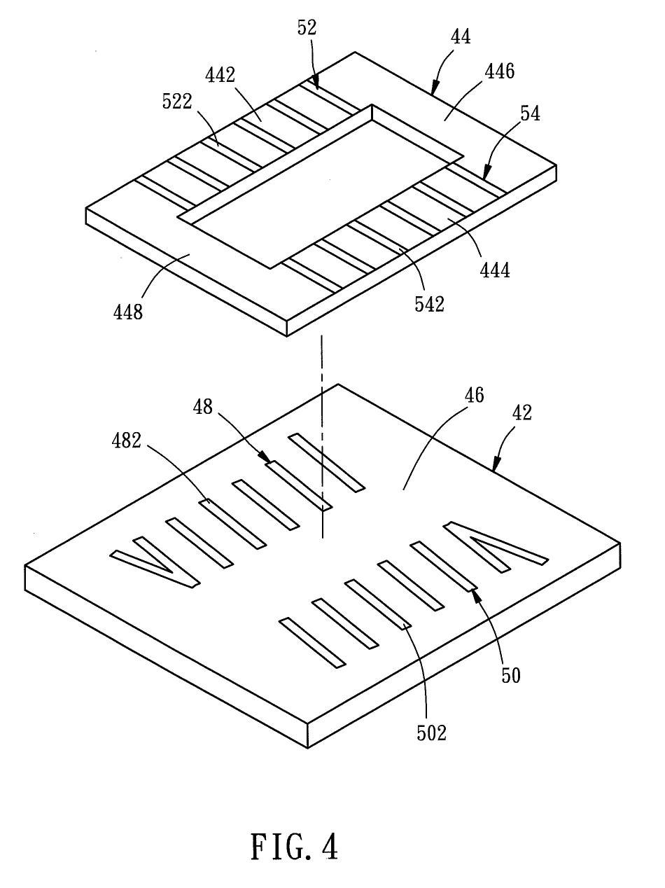

In this embodiment, first conductive bonding 30 has a plurality of first conductive wires 302 and each of first conductive wires 302 connects a first end of each of first lower conductive segments 202 to a first end of each of upper conductive segments 282. Second conductive bonding 32 has a plurality of second conductive bonding wires 322 and each of second conductive bonding wires 322 connects a second end of each of first lower conductive segments 202 to a second end of each of first upper of conductive segments 282. Referring secondly to FIGS. 3 and 4, a microtransformer 40 embodied according to the aspect of the present invention is shown. Microtransformer 40 includes an insulating substrate 42 and a first core 44 made of ferrite.

Insulating substrate 42 has an upper surface 46. A first lower primary and first secondary windings 48, 50 are disposed on upper surface 46 of substrate 42 in a parallel arrangement. First lower primary winding 48 has a series of first lower primary conductive segments 482 disposed on upper surface 46 of substrate 42 in a parallel arrangement. First lower secondary winding 50 has a series of first lower secondary conductive segments 502 disposed on upper surface 46 of substrate 42 in a parallel arrangement.

First core 44 defines a magnetic flux path including a first and second leg portions 442, 444 and a first and second arm portions 446, 448. First core 44 further includes a first upper primary winding 52 disposed on an upper surface of first leg portion 442 and a first upper secondary winding 54 disposed on an upper surface of second leg portion 444. First upper primary winding 52 has a series of first upper primary conductive segments 522 disposed on the upper surface of first leg portion 442 in a parallel arrangement. First upper secondary winding 54 is a series of first upper secondary conductive segments 542 disposed on the upper surface of second leg portion 444 in a parallel arrangement.

First core 44 is stacked over upper surface 46 of substrate 42 in such a way that First upper primary winding 52 corresponds to first lower primary winding 48, and first upper secondary winding 54 corresponds to first lower secondary winding 50.

Microtransformer 40 further comprises a first primary conductive bonding 60, a second primary conductive bonding 62, a first secondary conductive bonding 64 and a second secondary conductive bonding 66. First primary conductive bonding 60 has a series of first primary conductive wires 602. Second primary conductive bonding 62 has a series of second primary conductive wires 622. First secondary conductive bonding 64 has a series of first secondary conductive wires 642. Second secondary conductive bonding 66 has a series of second secondary conductive wires 662.

Each of first primary conductive wires 602 connects a first end of each of first lower primary conductive segments 482 to a first end of each of first upper primary conductive segments 522, and each of second primary conductive wires 622 connects a second end of each of first lower primary conductive segments 482 to a second end of each of first upper primary conductive segments 522 so as to form a primary inductor winding around first leg 442 of first core 44.

Each of first secondary conductive wires 642 connects a first end of each of first lower secondary conductive segments 502 to a first end of each of first upper secondary conductive segments 542, and each of second secondary conductive wires 662 connects a second end of each of first lower secondary conductive segments 502 to a second end of each of first upper secondary conductive segments 542 so as to form a secondary inductor winding around second leg 444 of first core 44.

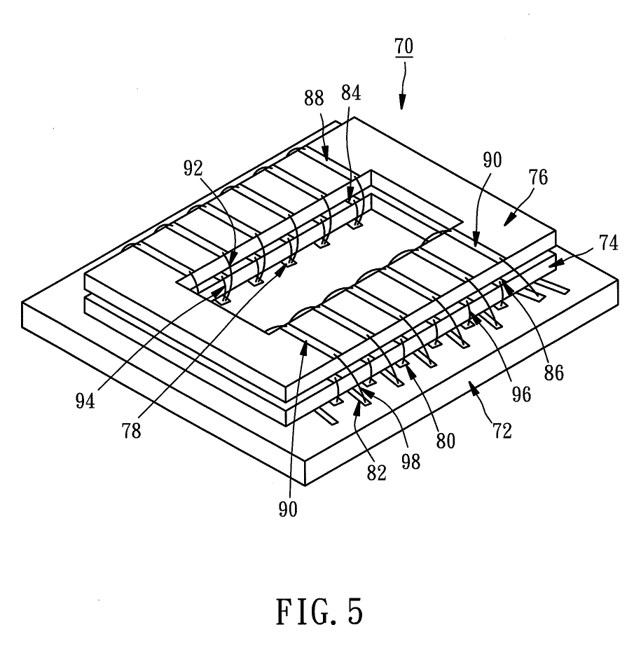

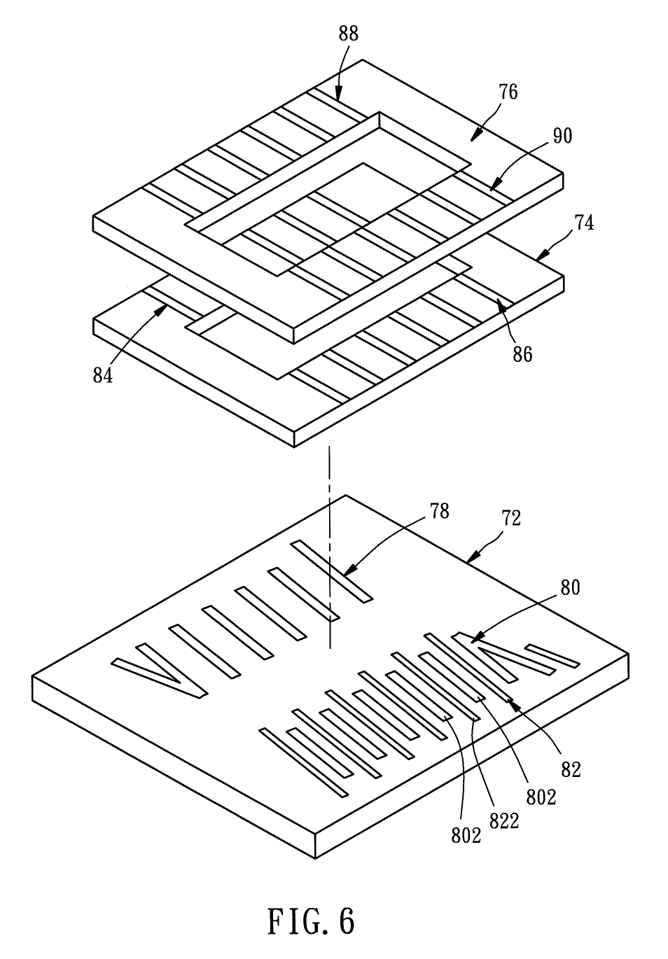

Lastly, referring to FIGS. 5 and 6, microtransformer 70 is another embodiment according to the aspect of the present invention. It includes an insulating substrate 72, a first core 74 and a second core 76.

Except having a first lower primary winding 78 and a first lower secondary windings 80, insulating substrate 72 can be designed to have a second lower primary winding or a second lower secondary winding or both.

In this embodiment, insulating substrate 72 further has a second lower secondary winding 82 including a series of second lower secondary conductive segments 822. Each of second lower secondary conductive segments 822 is sandwiched between each of first lower secondary conductive segments 802.

First core 74 and second core 76 are structured the same as core 44 of microtransformer 40. In this embodiment, first core 74 includes a first upper primary winding 84 and a first upper secondary winding 86. Second core 76 includes a second upper primary winding 88 and a second upper secondary winding 90.

In combination, first core 74 is stacked over substrate 72 and second core 76 is stacked over first core 74 in such a way that first upper primary winding 84 of first core 74 and second upper primary winding 88 of second core 76 are respectively connected with first lower primary winding 78 through a first upper bonding 92 and an first under bonding 94 to form two sets of primary inductor winding, first upper secondary winding 86 of first core 74 is connected with first lower secondary winding 80 through a second under bonding wires 96, second upper secondary winding 90 of second core 76 is connected with second lower secondary winding 82 through a second upper bonding wires 98 to form two sets of secondary inductor winding.

What is claimed is:

1. A microinductor, comprising:
a substrate made of insulating materials;
a lower conductive winding disposed on an upper surface of said substrate;
a core made of a material with high permeability stacked over said lower conductive winding; and
an upper conductive winding disposed on an upper surface of said core, said upper conductive winding electrically interconnecting with said lower conductive winding to form an inductor coil.

2. The microinductor of claim 1, wherein said lower conductive winding comprises a series of lower conductive segments disposed on said upper surface of said substrate in a parallel arrangement.

3. The microinductor of claim 2, wherein said upper conductive winding comprises a series of upper conductive segments disposed on said upper surface of said core in a parallel arrangement.

4. The microinductor of claim 3, further comprising a plurality of first conductive bonding wires and a plurality of second conductive bonding wires; each of said first conductive bonding wires connecting a first end of each of said first lower conductive segments to a first end of each of said upper conductive segments; each of said second conductive bonding wires connecting a second end of each of said first lower conductive segments to a second end of each of said first upper of conductive segments so as to form an inductor winding around said core.

5. A microtransformer, comprising:
a substrate made of insulating materials;
a first lower primary and first secondary windings disposed on an upper surface of said substrate in a parallel arrangement;
a first core made of a material with high permeability and defining a magnetic flux path including a first and second leg portions and a first and second arm portions, said core further including a first upper primary winding disposed on an upper surface of said first leg portion, and a first upper secondary winding disposed on an upper surface of said second leg portion;
said first core being stacked over said upper surface of said substrate in such a way that said first upper primary winding corresponds to said first lower primary winding, and said first upper secondary winding corresponds to said first lower secondary winding;
a first primary conductive bonding connecting a first end of said first upper primary winding to a first end of said first lower primary winding, and a second primary conductive bonding connecting a second end of said first upper primary winding to a second end of said first lower primary winding so as to form a first primary inductor winding; and
a first secondary conductive bonding connecting a first end of said first upper secondary winding to a first end of said first lower secondary winding, and a second secondary conductive bonding connecting a second end of said first upper secondary winding to a second end of said first lower secondary winding so as to form a first secondary inductor winding.

6. The microtransformer of claim 5, wherein said first lower primary winding includes a series of first lower primary conductive segments disposed on said upper surface of said substrate in a parallel arrangement.

7. The microtransformer of claim 6, wherein said first lower secondary winding includes a series of first lower secondary conductive segments disposed on said upper surface of said substrate in a parallel arrangement.

8. The microtransformer of claim 7, wherein said first upper primary winding includes a series of first upper primary conductive segments disposed on said upper surface of said first leg portion of said core in a parallel arrangement.

9. The microtransformer of claim 8, wherein said first upper secondary winding includes a series of first upper secondary conductive segments disposed on said upper surface of said second leg portion of said core in a parallel arrangement.

10. The microtransformer of claim 9, wherein said first primary conductive bonding includes a series of first primary conductive wires, said second primary conductive bonding includes a series of second primary conductive wires, each of said first primary conductive wires connecting a first end of each of said first lower primary conductive segments to a first end of each of said first upper primary conductive segments; each of said second primary conductive wires connecting a second end of each of said first lower primary conductive segments to a second end of each of said first upper primary conductive segments so as to form a primary inductor winding around said first leg of said first core.

11. The microtransformer of claim 9, wherein said first secondary conductive bonding includes a series of first secondary conductive wires, said second secondary conductive bonding includes a series of second secondary conductive wires, each of said first secondary conductive wires connecting a first end of each of said first lower secondary conductive segments to a first end of each of said first upper secondary conductive segments; each of said second secondary conductive wires connecting a second end of each of said first lower secondary conductive segments to a second end of each of said first upper secondary conductive segments so as to form a secondary inductor winding around said second leg of said first core.

12. The microtransformer of claim 11, further comprising a second core made of a material with high permeability and defining a magnetic flux path including a third and fourth leg portions and a third and fourth arm portions, said second core further including a series of second upper primary conductive segments disposed on an upper surface of said third leg portion of said second core in a parallel arrangement, a series of second upper secondary conductive segments disposed on said upper surface of said second leg portion of said core in a parallel arrangement;
said second core being stacked over said first core in such a way that said series of second upper primary conductive segments corresponds to said series of first upper primary conductive segments of said first core, and said series of second upper secondary conductive segments corresponds to said series of first upper secondary conductive segments of said first core;
a series of third primary conductive wires, each of said third primary conductive wires connecting a first end of each of said second upper primary conductive segments to a first end of each of said first lower primary conductive segments;
a series of fourth primary conductive wires, each of said fourth primary conductive wires connecting a second end of each of said second upper primary conductive segments to a second end of each of said first lower primary conductive segments so as to form a second primary inductor winding around said third leg of said second core;
a series of third secondary conductive wires, each of said third secondary conductive wires connecting a first end of each of said second upper secondary conductive segments to a first end of each of said first lower secondary conductive segments; and
a series of fourth secondary conductive wires, each of said fourth secondary conductive wires connecting a second end of each of said second upper secondary conductive segments to a second end of each of said first lower secondary conductive segments so as to form a second secondary inductor winding around said fourth leg of said second core.

13. The microtransformer of claim 11, further comprising a second core made of a material with high permeability and defining a magnetic flux path including a third and fourth leg portions and a third and fourth arm portions, said second core further including a series of second upper primary conductive segments disposed on an upper surface of said third leg portion of said second core in a parallel arrangement, a series of second upper secondary conductive segments disposed on said upper surface of said second leg portion of said core in a parallel arrangement;
a second lower secondary winding including a series of second lower secondary conductive segments disposed on said upper surface of said substrate, each of said second lower secondary conductive segments sandwiched between each of said first lower secondary conductive segments.
said second core being stacked over said first core in such a way that said series of second upper primary conductive segments corresponds to said series of first upper primary conductive segments of said first core, and said series of second upper secondary conductive segments corresponds to said series of first upper secondary conductive segments of said first core;
a series of third primary conductive wires, each of said third primary conductive wires connecting a first end of each of said second upper primary conductive segments to a first end of each of said first lower primary conductive segments;
a series of fourth primary conductive wires, each of said fourth primary conductive wires connecting a second end of each of said second upper primary conductive segments to a second end of each of said first lower primary conductive segments so as to form a second primary inductor winding around said third leg of said second core;
a series of third secondary conductive wires, each of said third secondary conductive wires connecting a first end of each of said second upper secondary conductive segments to a first end of each of said second lower secondary conductive segments; and
a series of fourth secondary conductive wires, each of said fourth secondary conductive wires connecting a second end of each of said second upper secondary conductive segments to a second end of each of said second lower secondary conductive segments so as to form a second secondary inductor winding around said fourth leg of said second core.
